(19) United States
(12) Patent Application Publication
(10) Pub. No.: US 2025/0150367 A1
(43) Pub. Date: May 8, 2025

(54) NETWORK INFORMATION VISUALIZATION DEVICE, NETWORK INFORMATION VISUALIZATION METHOD, NETWORK INFORMATION VISUALIZATION PROGRAM, AND NETWORK INFORMATION VISUALIZATION SYSTEM

(71) Applicant: NIPPON TELEGRAPH AND TELEPHONE CORPORATION, Tokyo (JP)

(72) Inventors: Yuhei HAYASHI, Tokyo (JP); Satomi INOUE, Tokyo (JP); Atsushi SUTO, Tokyo (JP)

(73) Assignee: NIPPON TELEGRAPH AND TELEPHONE CORPORATION, Tokyo (JP)

(21) Appl. No.: 18/832,729

(22) PCT Filed: Feb. 3, 2022
(86) PCT No.: PCT/JP2022/004313

§ 371 Date: Jul. 24, 2024

(51) Int. Cl. H04L 43/045; H04L 43/062; H04L 43/065

(52) U.S. Cl. CPC H04L 43/045; H04L 43/062; H04L 43/065

(57) ABSTRACT

Provided are a network information visualization device, a network information visualization method, a network information visualization program, and a network information visualization system that visualizes useful information in network monitoring and improve reliability of a network. An information acquisition unit (11) acquires network information regarding a VPN network (2) including at least flow information having statistical information regarding communication in the VPN network (2). An association unit (12) associates the flow information with another network information included in the network information and generates associated flow information. A visualization unit (14) generates visualization information in which the flow information is associated with the other network information based on the associated flow information.

### TECHNICAL FIELD

The present invention relates to a network information visualization device, a network information visualization method, a network information visualization program, and a network information visualization system.

### BACKGROUND ART

In recent years, technologies such as multi-protocol label switching (MPLS), a virtual private network (VPN), and a Layer 2 tunneling protocol (L2TP) VPN have been provided as means for realizing VPN in a carrier network. With progress of such virtualization, the network has become complicated. Accordingly, for appropriate operation of the network, monitoring of the network has become more important.

In the network monitoring, various traffic acquisition technologies such as a simple network management protocol (SNMP) and an internet protocol flow Information export (IPFIX) are used. Then, by using each acquisition technology, various traffic information that can be visualized regarding the network using the VPN technology can be obtained. For example, interface (IF) statistical information can be obtained by using SNMP as the traffic acquisition technology. Further, by using IPFIX as the traffic acquisition technology, MPLS label statistical information and Inner 5-tuple statistical information can be obtained.

Conventionally, there has been proposed a format conversion device that acquires a header sample including an outer header of a header of an encapsulation packet and an inner header of an in-capsule packet, excludes the outer header to perform format conversion, and stores correspondence information between the inner header and the outer header. By using this format conversion device for a header sample acquired by using IPFIX, it is possible to obtain information on a fine granularity flow of a network using VPN. The fine granularity flow includes information such as an MPLS label of a destination provider edge (PE) router, an identifier (ID) of an output interface, and an ID of an input interface. Hereinafter, the network using VPN is referred to as a VPN network.

### CITATION LIST

### Patent Literature

Patent Literature 1: JP 2021-90161 A

### SUMMARY OF INVENTION

### Technical Problem

However, the fine granularity flow obtained in the VPN network includes statistical information related to VPN communication, but does not include various types of information such as topology information, setting information and operation information on a network device, and location information on the network device. Therefore, even if the information on the fine granularity flow obtained in the VPN network is used alone, it is difficult to visualize various information that is considered to be useful in operation of the VPN network. Examples of the information that is considered to be useful in the operation of the VPN network include information on a traffic time series for each VPN, information on a path, information on a geographical use tendency, and information on earth alternating current.

The present invention has been made in view of the above, and an object thereof is to visualize useful information in network monitoring and improve reliability of a network.

### Solution to Problem

In order to solve the above-described problem and achieve the object, an information acquisition unit acquires network information regarding a predetermined VPN network including at least flow information having statistical information regarding communication in the predetermined VPN network. An association unit associates the flow information with another network information included in the network information and generates associated flow information. A visualization unit generates visualization information in which the flow information is associated with the other network information based on the associated flow information.

### Advantageous Effects of Invention

According to the present invention, it is possible to visualize useful information in network monitoring and improve reliability of a network.

### BRIEF DESCRIPTION OF DRAWINGS

FIG. 1 is a block diagram of a network information visualization device.

FIG. 2 is a diagram illustrating a flow of generating visualization information according to an embodiment.

FIG. 3 is a diagram illustrating an information acquisition method and traffic granularity that can be visualized.

FIG. 4 is a diagram for describing data association.

FIG. 5 is a flowchart of network information visualization processing by the network information visualization device according to the embodiment.

FIG. 6 is a diagram for describing traffic visualization processing.

FIG. 7 is a diagram for describing path visualization processing.

FIG. 8 is a diagram for describing geographic visualization processing.

FIG. 9 is a diagram for describing earth alternating current visualization processing.

FIG. 10 is a flowchart of a specific example of the network information visualization processing by the network information visualization device according to the embodiment.

FIG. 11 is a diagram illustrating an example of a computer that executes a network information visualization program.

### DESCRIPTION OF EMBODIMENTS

Hereinafter, an embodiment of a network information visualization device, a network information visualization method, a network information visualization program, and a network information visualization system disclosed in the present application will be described in detail with reference to the drawings. Note that the network information visualization device, the network information visualization method, the network information visualization program, and the network information visualization system disclosed in the present application are not limited by the following embodiment.

### [Configuration of Network Information Visualization System]

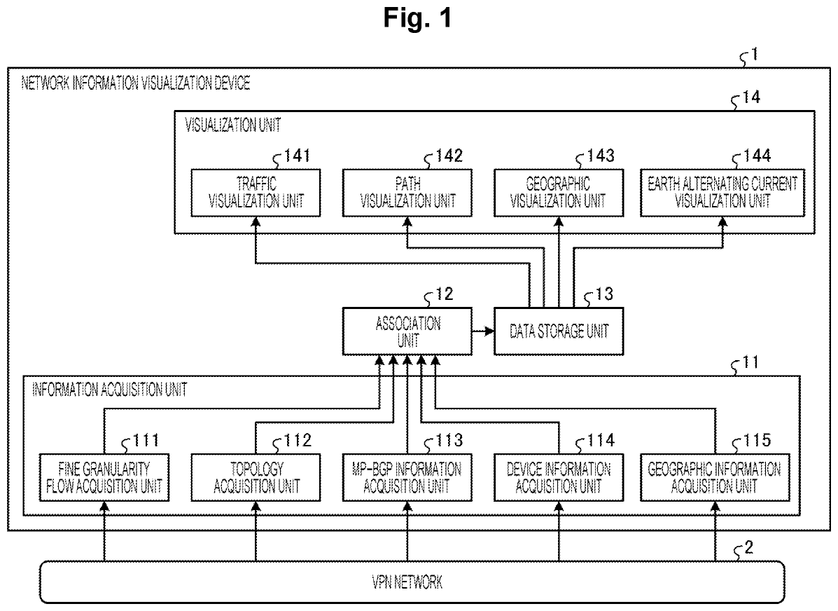

A configuration of a network information visualization device will be described with reference to FIG. 1. FIG. 1 is a block diagram of the network information visualization device. A network information visualization device 1 is an information processing device such as a server. The network information visualization device 1 is a device that visualizes information on a fine granularity flow obtained from a network that realizes VPN by associating the information with various types of information so that a user can easily grasp a state of the network. As illustrated in FIG. 1, the network information visualization device 1 is connected to a VPN network 2.

Here, the flow refers to a flow of a signal transmitted through a line. The fine granularity flow is an information group in which statistical information related to communication such as MPLS label statistical information and Inner 5-tuple statistical information is stored at high density. The high density corresponds to fine granularity of information. For example, the fine granularity flow may include information on a flow having fine granularity in a time direction. This fine granularity flow corresponds to an example of “flow information”.

### [VPN Network]

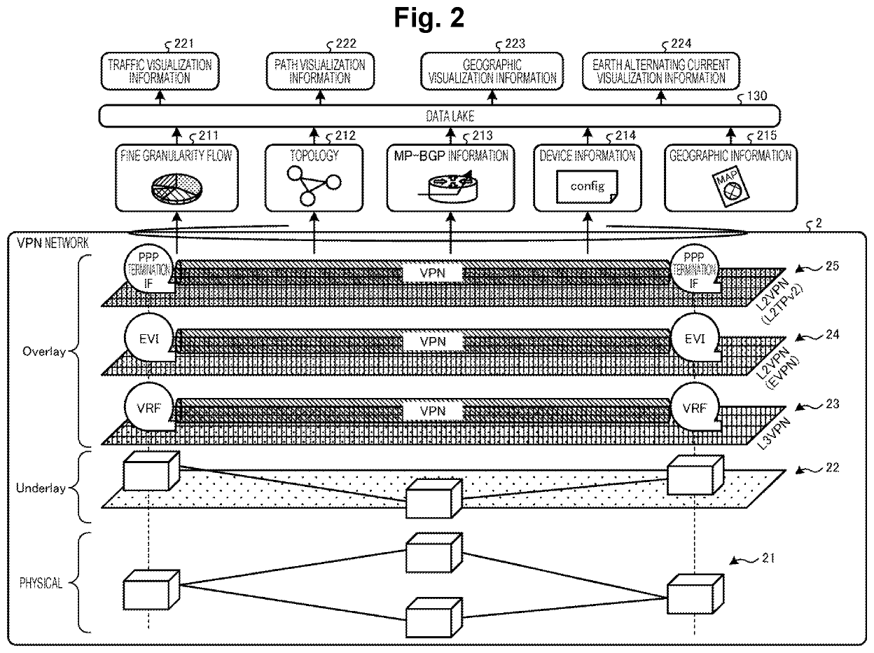

FIG. 2 is a diagram illustrating a flow of generating visualization information according to the embodiment; As illustrated in FIG. 2, the VPN network 2 includes a physical network 21, an underlay network 22, and VPNs 23 to 25 that are overlay networks.

The physical network 21 is a physical network including network devices such as a router and a switch and a network line connecting them. In the physical network 21, logical setting or the like for a network switch or the like is not performed.

The underlay network 22 is a physical network in which a plurality of logical paths is formed so as to connect bases and devices on the physical network 21. The underlay network 22 is formed by performing various logical settings such as restrictions on connection destinations and connection methods such as a reception source and a transmission destination of a signal to the network device such as a router in the physical network 21.

The overlay network is a virtual logical network constructed on the underlay network 22. The VPN 23 is Layer 3 (L3) VPN. The VPN 23 is distinguished and used by Virtual Routing and Forwarding (VRF) by a router, for example. The VPN 24 is L2VPN realized by Ethernet VPN (EVPN). The VPN 24 is distinguished and used by an EVPN instance (EVI). The VPN 25 is L2VPN realized by L2TPv2. The VPN 25 is formed between Point to Point Protocol (PPP) termination IFs. MPLS/SR-MPLS VPN using MPLS, source routing (SR)-MPLS, or the like includes L3VPN such as the VPN 23 and L2VPN implemented by EVPN such as the VPN 24. Further, L2TP VPN using L2TPv2 (Version 2) includes L2VPN such as the VPN 25.

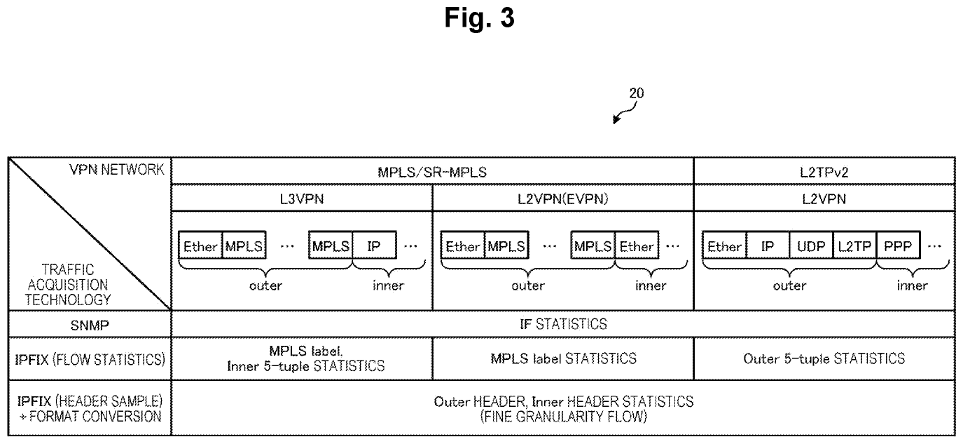

FIG. 3 is a diagram illustrating an information acquisition method and traffic granularity that can be visualized. For each of the VPNs 23 and 24 using MPLS or SR-MPLS and the VPN 25 using L2TPv2, packets in each format illustrated in FIG. 3 are transmitted and received.

When SNMP is used as traffic acquisition technology, IF statistical information is obtained for both the VPNs 23 and 24 which are MPLS/SR-MPLS VPNs and the VPN 25 which is L2TPv2 VPN. In addition, when IPFIX is used as the traffic acquisition technology, MPLS label statistical information and Inner 5-tuple statistical information are obtained in the VPN 23 that is Layer 3 (L3) VPN of MPLS/SR-MPLS VPNs. In addition, MPLS label statistical information is obtained in the VPN 24 which is L2VPN realized by EVPN of MPLS/SR-MPLS VPNs. Further, Outer 5-tuple statistical information is obtained in the VPN 25 which is L2VPN using L2TPv2 (Version 2).

In any of the VPNs 23 and 24 using MPLS or SR-MPLS and the VPN 25 using L2TPv2, Outer header statistical information and Inner header statistical information are obtained from a header sample acquired by using IPFIX. Moreover, a fine granularity flow can be obtained by combining the header sample acquired by using IPFIX and format conversion.

### [Configuration of Network Information Visualization Device]

Referring back to FIG. 1, the network information visualization device 1 will be described. As illustrated in FIG. 1, the network information visualization device 1 includes an information acquisition unit 11, an association unit 12, a data storage unit 13, and a visualization unit 14.

The information acquisition unit 11 acquires network information regarding the VPN network 2. The information acquisition unit 11 includes a fine granularity flow acquisition unit 111, a topology acquisition unit 112, a Multiprotocol-Border Gateway Protocol (MP-BGP) information acquisition unit 113, a device information acquisition unit 114, and a geographic information acquisition unit 115.

The fine granularity flow acquisition unit 111 acquires a header sample from the VPN network 2 using IPFIX for each of the VPNs 23 to 25. Further, the fine granularity flow acquisition unit 111 excludes an outer header from the acquired header sample and performs format conversion. Furthermore, the fine granularity flow acquisition unit 111 stores correspondence information between an inner header and the outer header. Then, the fine granularity flow acquisition unit 111 acquires a fine granularity flow 211 illustrated in FIG. 2 including MPLS label statistical information, Inner 5-tuple statistical information, and the like for each of the VPNs 23 to 25.

The fine granularity flow 211 includes, for example, a destination PE MPLS label, a VPN MPLS label, Inner Ether, Inner IP, Outer IP, Tunnel ID, Session ID, a sampling rate, and a statistical value. The destination PE MPLS label is an MPLS label of a destination PE router. The VPN MPLS label is an MPLS label of each of the VPNs 23 to 25. Further, Inner Ether is information regarding an internal network. Further, Inner IP is IP information used in the internal network. Further, Outer IP is IP information used in an external network. In addition, a Tunnel ID is identification information on a virtual tunnel used in each of the VPNs 23 to 25. In addition, Session ID is identification information on a session established in each of the VPNs 23 to 25. In addition, the statistical value includes traffic statistical information such as inner header and outer header statistical information, MPLS label statistical information, and Inner 5-tuple statistical information.

That is, the fine granularity flow 211 includes statistical information regarding communication in a predetermined VPN network, identification information regarding a plurality of network devices arranged in the predetermined VPN network, VPN communication setting information regarding signal transmission and reception in VPNs existing in the VPN network, and VPN communication setting information regarding signal transmission and reception in VPNs existing in the predetermined VPN network.

The fine granularity flow acquisition unit 111 outputs the fine granularity flow 211 for each of the VPNs 23 to 25 to the association unit 12.

The topology acquisition unit 112 acquires information on a topology 212 illustrated in FIG. 2 of the underlay network 22 from the VPN network 2. The topology 212 includes topology information including a connection relationship between the network devices, an ID of an output IF, an ID of an input IF, a router ID, and the like in each router. That is, the topology 212 includes identification information regarding the network devices and topology information indicating a connection relationship between the network devices. The topology acquisition unit 112 outputs the acquired information on the topology 212 to the association unit 12.

The MP-BGP information acquisition unit 113 acquires MP-BGP information 213 illustrated in FIG. 2 including network routing information such as routing information on VRF related to the VPN 23 from the VPN network 2. The MP-BGP information 213 includes a destination PE MPLS label, a VPN MPLS label, Inner Ether, and Inner IP. In addition, the MP-BGP information 213 includes PPP termination IF, Tunnel ID, and Session ID. That is, the MP-BGP information 213 can be said to be VPN information including VPN communication setting information related to signal transmission and reception in the VPNs 23 to 25 existing in the VPN network 2 and VPN identification information for identifying the VPNs 23 to 25. Then, the MP-BGP information acquisition unit 113 outputs the acquired MP-BGP information 213 to the association unit 12.

The device information acquisition unit 114 acquires, from the VPN network 2, device information 214 illustrated in FIG. 2 including device setting information and operating state information on each network device included in the physical network 21. The device information 214 includes VPN information including setting information such as a configuration of each of the VPNs 23 to 25, an RD value, and PPP termination IF information. That is, the device information 214 includes VPN identification information, and device setting information and operating state information on the network devices. Then, the device information acquisition unit 114 outputs the acquired device information 214 to the association unit 12.

The geographic information acquisition unit 115 acquires geographic information 215 illustrated in FIG. 2 including arrangement information on each network device included in the physical network 21 from the VPN network 2. The geographic information 215 includes latitude and longitude information indicating latitude and longitude of each network device and topology information. That is, the geographic information 215 includes topology information and location information on the network devices. Then, the geographic information acquisition unit 115 outputs the acquired geographic information 215 to the association unit 12.

As described above, the information acquisition unit 11 acquires network information regarding a predetermined VPN network including at least flow information having statistical information regarding communication in the predetermined VPN network. In addition, the information acquisition unit 11 acquires flow information including identification information regarding a plurality of network devices arranged in the VPN network and a topology including the identification information regarding the network devices and topology information indicating a connection relationship between the network devices. In addition, the information acquisition unit 11 acquires geographic information including the topology information and the location information on the network devices. In addition, the information acquisition unit 11 acquires flow information including VPN communication setting information regarding signal transmission and reception in VPNs existing in the predetermined VPN network, VPN information including the VPN communication setting information and VPN identification information for identifying the VPNs, and device information including the VPN identification information, and the device setting information and operating state information on the network devices.

The association unit 12 receives an input of the fine granularity flow 211 from the fine granularity flow acquisition unit 111. Furthermore, the association unit 12 receives an input of the information on the topology 212 from the topology acquisition unit 112. Further, the association unit 12 receives an input of the MP-BGP information 213 from the MP-BGP information acquisition unit 113. Furthermore, the association unit 12 receives an input of the device information 214 from the device information acquisition unit 114. Further, the association unit 12 receives an input of the geographic information 215 from the geographic information acquisition unit 115.

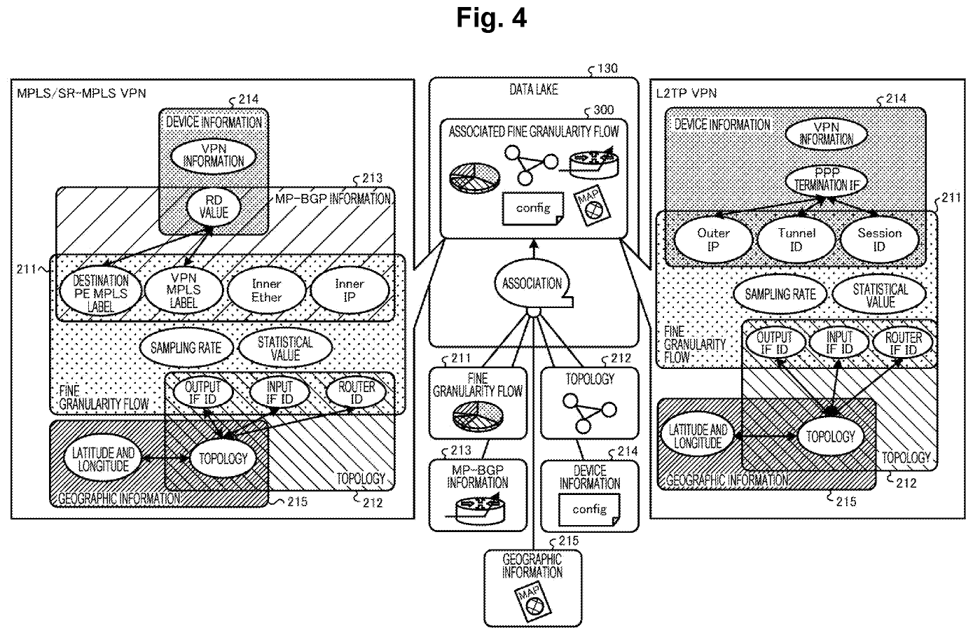

Next, the association unit 12 associates each data with each of the VPNs 23 and 24 that are MPLS/SR-MPLS VPNs and the VPN 25 that is L2TP VPN. FIG. 4 is a diagram for describing data association.

The association unit 12 executes the following processing on the VPNs 23 and 24 that are MPLS/SR-MPLS VPNs. The association unit 12 associates the fine granularity flow 211 with the topology 212 by, for example, the output IF ID, the input IF ID, and the router ID. Further, the association unit 12 associates the fine granularity flow 211 with the MP-BGP information 213 by, for example, the destination PE MPS label, the VPN MPLS label, Inner Ether, and Inner IP.

Next, the association unit 12 associates the RD value, which associates the MP-BGP information 213 with the device information 214, with the destination PE MPLS label and the VPN MPLS label. As a result, the association unit 12 associates the fine granularity flow 211 with the device setting information and operating state information on each network device included in the device information 214 via the MP-BGP information 213.

Further, the association unit 12 associates the topology information, which associates the topology 212 with the geographic information 215, with the output IF ID, the input IF ID, and the router ID. As a result, the association unit 12 associates the fine granularity flow 211 with the latitude and longitude information on each network device included in the geographic information 215 via the topology 212.

On the other hand, the association unit 12 executes the following processing on the VPN 25 that is L2TP VPN. The association unit 12 associates the fine granularity flow 211 with the topology 212 by, for example, the output IF ID, the input IF ID, and the router ID. Then, the association unit 12 associates the topology information, which associates the topology 212 with the geographic information 215, with the output IF ID, the input IF ID, and the router ID. As a result, the association unit 12 associates the fine granularity flow 211 with the latitude and longitude information on each network device included in the geographic information 215 via the topology 212.

In addition, the association unit 12 associates, for example, Outer IP, Tunnel ID, and Session ID included in the fine granularity flow 211 with the PPP termination IF information included in the device information 214. As a result, the association unit 12 associates the fine granularity flow 211 with the device setting information and operating state information on each network device included in the device information 214 via the MP-BGP information 213.

Through the above processing, the association unit 12 generates an associated fine granularity flow 300 in which the topology 212, the MP-BGP information 213, the device information 214, and the geographic information 215 are associated with the fine granularity flow 211. The associated fine granularity flow 300 corresponds to an example of “associated flow”. Then, the association unit 12 stores the generated associated fine granularity flow 300 in the data storage unit 13.

As described above, the association unit 12 associates the flow information with the other network information included in the network information and generates the associated flow information. Further, the association unit 12 associates the identification information related to the network devices with the topology information. Furthermore, the association unit 12 associates the topology information with the location information. Further, the association unit 12 associates the VPN communication setting information with the VPN identification information.

Referring back to FIG. 1, the description is continued. The data storage unit 13 acquires the associated fine granularity flow 300 from the association unit 12. Then, the data storage unit 13 collectively holds the acquired associated fine granularity flow 300 as a data lake 130 illustrated in FIGS. 2 and 4.

The visualization unit 14 generates visualization information in which a fine granularity flow is associated with other network information by using the associated fine granularity flow 300 stored in the data storage unit 13 and provides the visualization information for a user. The visualization unit 14 generates visualization information that visualizes a traffic time series for each VPN, a communication path, a geographic use tendency, and earth alternating current. Then, the visualization unit 14 generates a visualization screen or the like for displaying the generated visualization information and provides the generated visualization screen or the like for the user. Here, the visualization unit 14 may visualize other information useful in operation of the VPN network 2 in addition to the information listed above.

As described above, the visualization unit 14 generates the visualization information in which the flow information is associated with the other network information on the basis of the associated flow information. In addition, the visualization unit 14 generates traffic visualization information that visualizes a traffic time series related to a predetermined VPN or a predetermined communication interface at a predetermined time on the basis of the statistical information. In addition, the visualization unit 14 generates path visualization information that visualizes a path through which predetermined communication has passed at a predetermined time on the basis of the identification information regarding the network devices, the topology information, and the statistical information. In addition, the visualization unit 14 generates geographic visualization information that visualizes a geographic distribution of predetermined communication at a predetermined time on the basis of the identification information regarding the network devices, the location information, and the statistical information. In addition, the visualization unit 14 generates earth alternating current visualization information that visualizes earth alternating current between predetermined network devices at a predetermined time on the basis of the statistical information and the device information.

Here, entire visualization information generation processing will be collectively described with reference to FIG. 2. The information acquisition unit 11 acquires the fine granularity flow 211, the topology 212, the MP-BGP information 213, the device information 214, and the geographic information 215 from the VPN network 2. Next, the association unit 12 associates the topology 212, the MP-BGP information 213, the device information 214, and the geographic information 215 with the fine granularity flow 211 and generates the associated fine granularity flow 300. Thereafter, the association unit 12 stores the associated fine granularity flow 300 in the data storage unit 13 to form the data lake 130. The visualization unit 14 generates, using the associated fine granularity flow 300, traffic visualization information 221 that visualizes a traffic time series for each VPN, path visualization information 222 that visualizes a communication path, geographic visualization information 223 that visualizes geographic use tendency, and earth alternating current visualization information 224 that visualizes earth alternating current, and provides the generated information for the user.

### [Network Information Visualization Processing]

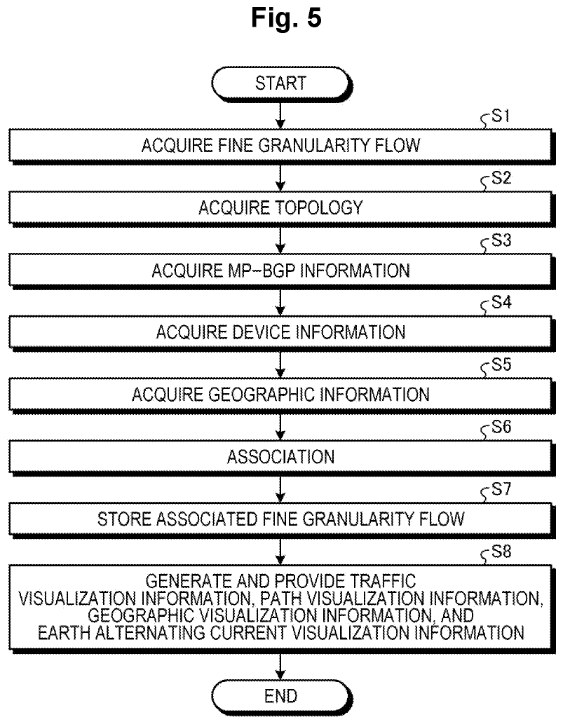

FIG. 5 is a flowchart of network information visualization processing by the network information visualization device according to the embodiment. Next, a flow of the network information visualization processing by the network information visualization device 1 according to the embodiment will be described with reference to FIG. 5.

The fine granularity flow acquisition unit 111 acquires a header sample from the VPN network 2 using IPFIX. Then, the fine granularity flow acquisition unit 111 performs format conversion on the header sample to acquire the fine granularity flow 211 related to the VPNs 23 to 25 (step S1). Thereafter, the fine granularity flow acquisition unit 111 outputs the acquired fine granularity flow 211 to the association unit 12.

The topology acquisition unit 112 acquires the topology 212 of the physical network 21 and the underlay network 22 from the VPN network 2 (step S2). Thereafter, the topology acquisition unit 112 outputs the information on the topology 212 to the association unit 12.

The MP-BGP information acquisition unit 113 acquires the MP-BGP information 213 from the VPN network 2 (step S3). Thereafter, the MP-BGP information acquisition unit 113 outputs the MP-BGP information 213 to the association unit 12.

The device information acquisition unit 114 acquires the device information 214 including the device setting information and the operating state information on the network devices from the VPN network 2 (step S4). Thereafter, the device information acquisition unit 114 outputs the device information 214 to the association unit 12.

The geographic information acquisition unit 115 acquires the geographic information 215 including the latitude and longitude information on the network devices from the VPN network 2 (step S5). Thereafter, the geographic information acquisition unit 115 outputs the geographic information 215 to the association unit 12.

The association unit 12 associates the topology 212, the MP-BGP information 213, the device information 214, and the geographic information 215 with the fine granularity flow 211 for each of the VPNs 23 and 24 that are MPLS/SR-MPLS VPNs and the VPN 25 that is L2TP VPN (step S6).

Next, the association unit 12 stores the associated fine granularity flow 300 generated by association in the data storage unit 13 to generate the data lake 130 (step S7).

The visualization unit 14 generates the traffic visualization information 221, the path visualization information 222, the geographic visualization information 223, and the earth alternating current visualization information 224 using the associated fine granularity flow 300. Then, the visualization unit 14 provides the traffic visualization information 221, the path visualization information 222, the geographic visualization information 223, and the earth alternating current visualization information 224 for a user (step S8).

### [Example of Visualization Information Generation Processing]

For example, the visualization unit 14 can generate and provide the traffic visualization information 221, the path visualization information 222, the geographic visualization information 223, and the earth alternating current visualization information 224 by the following method. As illustrated in FIG. 1, the visualization unit 14 can include a traffic visualization unit 141, a path visualization unit 142, a geographic visualization unit 143, and an earth alternating current visualization unit 144.

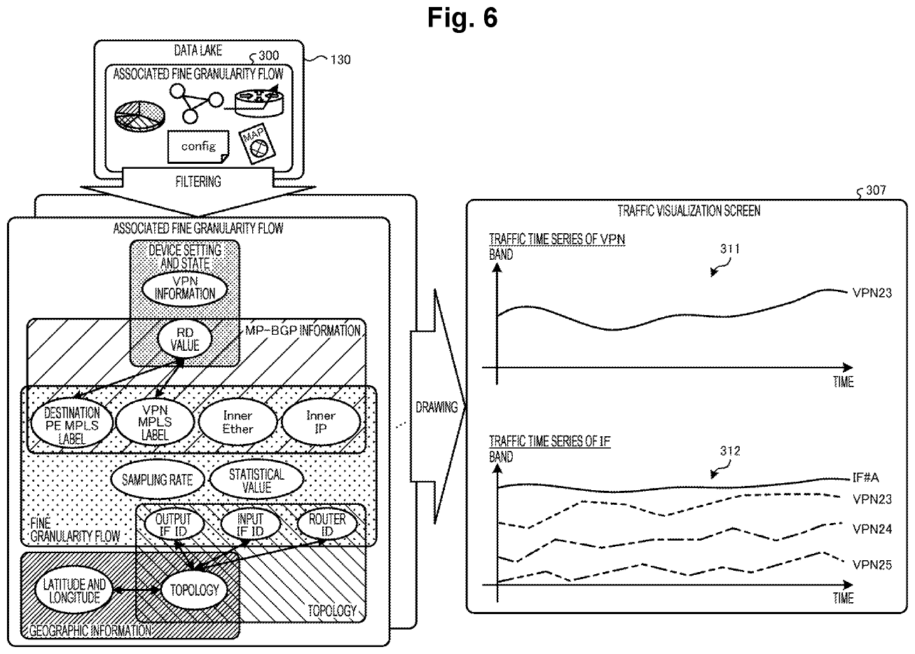

FIG. 6 is a diagram for describing traffic visualization processing. Operation of the traffic visualization unit 141 will be described with reference to FIG. 6. The traffic visualization unit 141 performs filtering for a predetermined time and a predetermined field value on the associated fine granularity flow 300 included in the data lake 130, and acquires the associated fine granularity flow 300 subjected to the filtering. The field value is, for example, a value indicating any of the VPNs 23 to 25 or a value indicating a specific interface. The traffic visualization unit 141 can use designated values from an operator as the predetermined time and the predetermined field value. Then, the traffic visualization unit 141 collects statistical values included in the associated fine granularity flow 300 after the filtering and draws a time-series graph.

For example, the traffic visualization unit 141 generates a traffic visualization screen 301 illustrated in FIG. 6, displays the screen on a monitor or the like, and provides the traffic visualization information 221 for a user. The traffic visualization screen 301 includes, for example, a graph 311 representing a traffic time series of the VPN 23 and a graph 312 representing a traffic time series of an interface. In each of the graphs 311 and 312, the horizontal axis represents time and the vertical axis represents a band. The user can grasp a change in traffic of the VPN 23 over time from the graph 311. In addition, the user can grasp a change in traffic of an interface #A over time and changes in traffic of the VPN 23 to 25 at that time from the graph 312. In this manner, the traffic visualization unit 141 can visualize a traffic time series at a certain time of communication designated by a filter condition.

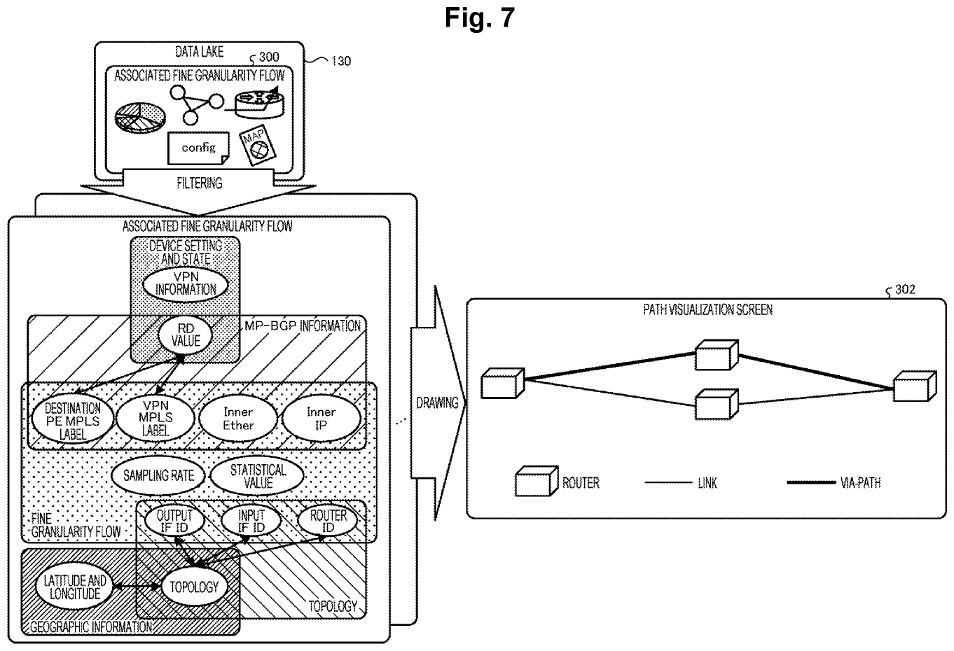

FIG. 7 is a diagram for describing path visualization processing. Operation of the path visualization unit 142 will be described with reference to FIG. 7. The path visualization unit 142 performs filtering for a predetermined time and a predetermined field value on the associated fine granularity flow 300 included in the data lake 130, and acquires the associated fine granularity flow 300 subjected to the filtering. The field value is, for example, a value indicating specific communication. The path visualization unit 142 can use designated values from an operator as the predetermined time and the predetermined field value. Then, the path visualization unit 142 collects the router ID, the output IF ID, and the input IF ID included in the associated fine granularity flow 300 after the filtering, maps them on the topology information, and draws the topology information.

For example, the path visualization unit 142 generates a path visualization screen 302 illustrated in FIG. 7, displays the screen on a monitor or the like, and provides the path visualization information 222 for the user. For example, as illustrated in FIG. 7, the path visualization screen 302 represents routers and links connecting the routers, and further represents via-paths on the links. The user can grasp how the network devices are connected and which path the via-path passes through on the path visualization screen 302. In this manner, the path visualization unit 142 can visualize a traffic time series at a certain time of communication designated by a filter condition.

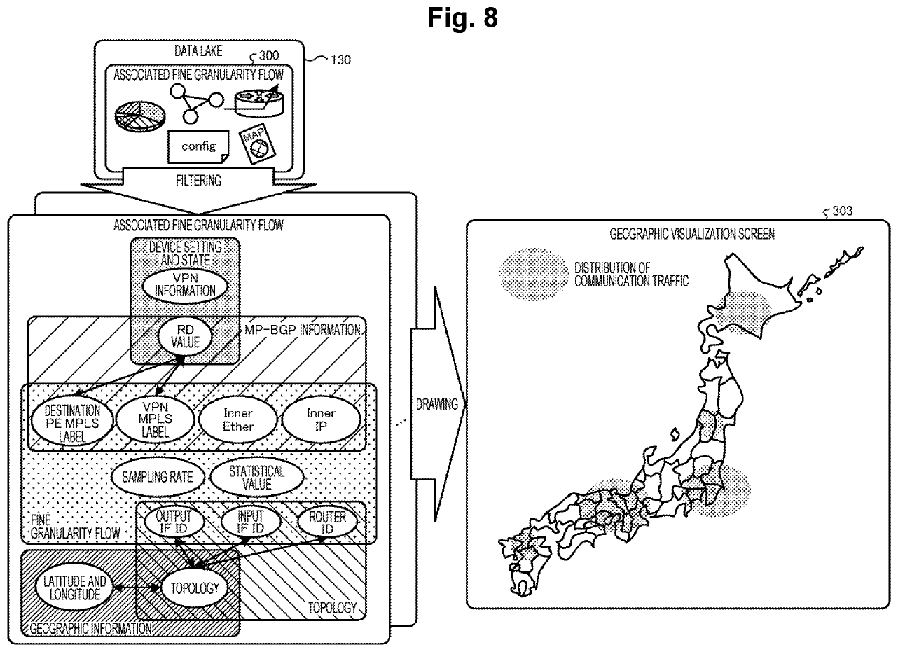

FIG. 8 is a diagram for describing geographic visualization processing. Operation of the geographic visualization unit 143 will be described with reference to FIG. 8. The geographic visualization unit 143 performs filtering for a predetermined time and a predetermined field value on the associated fine granularity flow 300 included in the data lake 130, and acquires the associated fine granularity flow 300 subjected to the filtering. The field value is, for example, a value indicating specific communication. The geographic visualization unit 143 can use designated values from an operator as the predetermined time and the predetermined field value. Then, the geographic visualization unit 143 collects the latitude and longitude information included in the associated fine granularity flow 300 after the filtering and draws a map indicating a distribution of communication.

For example, the geographic visualization unit 143 generates a geographic visualization screen 303 illustrated in FIG. 8, displays the screen on a monitor or the like, and provides the user with the geographic visualization information 223. For example, as illustrated in FIG. 8, the geographic visualization screen 303 can indicate communication traffic in each region by indicating a distribution of communication on a map. The user can grasp how much and which region communication has occurred on the geographic visualization screen 303. In this manner, the geographic visualization unit 143 can visualize, as a distribution, communication traffic at a certain time of communication designated by a filter condition.

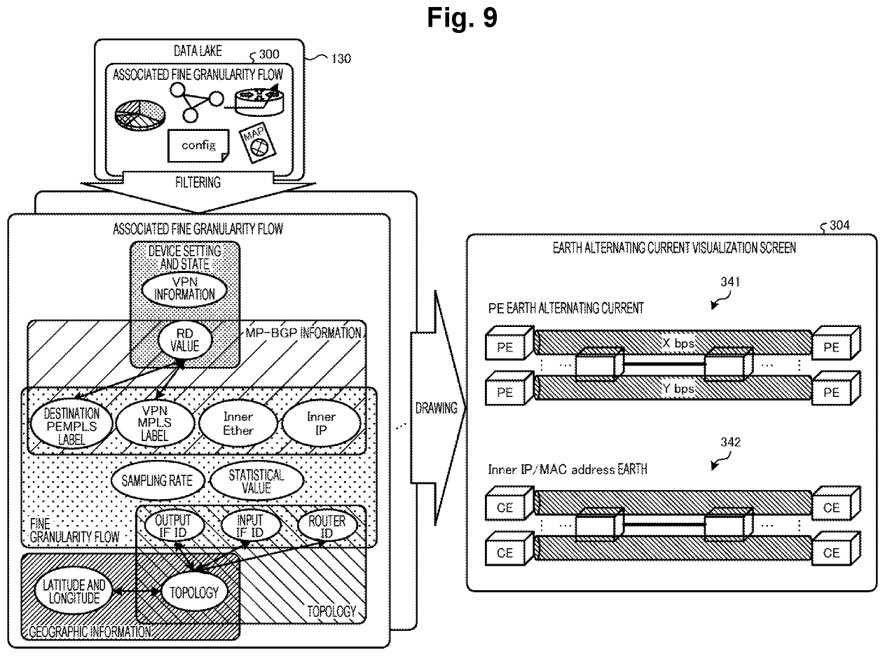

FIG. 9 is a diagram for describing earth alternating current visualization processing. Operation of the earth alternating current visualization unit 144 will be described with reference to FIG. 9. The earth alternating current visualization unit 144 performs filtering for a predetermined time and a predetermined field value on the associated fine granularity flow 300 included in the data lake 130, and acquires the associated fine granularity flow 300 subjected to filtering. The field value is, for example, a value indicating a specific network device. The earth alternating current visualization unit 144 can use designated values from an operator as the predetermined time and the predetermined field value. Then, the earth alternating current visualization unit 144 collects the destination PE MPLS label and IP addresses and MAC addresses of a transmission source and a transmission destination of a signal included in the associated fine granularity flow 300 after the filtering, and generates and draws earth alternating current information.

For example, the earth alternating current visualization unit 144 generates an earth alternating current visualization screen 304 illustrated in FIG. 9, displays the screen on a monitor or the like, and provides the earth alternating current visualization information 224 for the user. The earth alternating current visualization screen 304 includes, for example, a graph 341 representing earth alternating current between specific PE routers and a graph 342 representing earth alternating current between specific CE routers. With the graphs 341 and 342, the user can grasp whether or not earth alternating current exists between specific routers and communication traffic based on the earth alternating current. In this manner, the earth alternating current visualization unit 144 can visualize the presence or absence of earth alternating current and the traffic amount at a certain time between routers designated by a filter condition.

### [Specific Example of Network Information Visualization Processing]

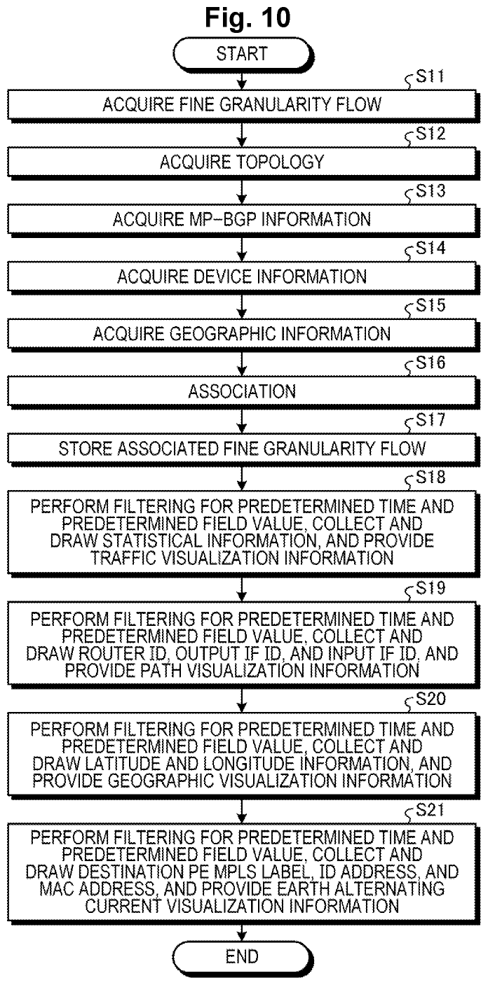

FIG. 10 is a flowchart of a specific example of the network information visualization processing by the network information visualization device according to the embodiment. Next, a flow of the specific example of the network information visualization processing by the network information visualization device 1 according to the embodiment will be described with reference to FIG. 10.

The fine granularity flow acquisition unit 111 acquires a header sample from the VPN network 2 using IPFIX. Then, the fine granularity flow acquisition unit 111 performs format conversion on the header sample to acquire the fine granularity flow 211 related to the VPNs 23 to 25 (step S11). Thereafter, the fine granularity flow acquisition unit 111 outputs the acquired fine granularity flow 211 to the association unit 12.

The topology acquisition unit 112 acquires the topology 212 of the physical network 21 and the underlay network 22 from the VPN network 2 (step S12). Thereafter, the topology acquisition unit 112 outputs the information on the topology 212 to the association unit 12.

The MP-BGP information acquisition unit 113 acquires the MP-BGP information 213 from the VPN network 2 (step S13). Thereafter, the MP-BGP information acquisition unit 113 outputs the MP-BGP information 213 to the association unit 12.

The device information acquisition unit 114 acquires the device information 214 including the device setting information and the operating state information on the network devices from the VPN network 2 (step S14). Thereafter, the device information acquisition unit 114 outputs the device information 214 to the association unit 12.

The geographic information acquisition unit 115 acquires the geographic information 215 including the latitude and longitude information on the network devices from the VPN network 2 (step S15). Thereafter, the geographic information acquisition unit 115 outputs the geographic information 215 to the association unit 12.

The association unit 12 associates the topology 212, the MP-BGP information 213, the device information 214, and the geographic information 215 with the fine granularity flow 211 for each of the VPNs 23 and 24 that are MPLS/SR-MPLS VPNs and the VPN 25 that is L2TP VPN (step S16).

Next, the association unit 12 stores the associated fine granularity flow 300 generated by association in the data storage unit 13 to generate the data lake 130 (step S17).

The traffic visualization unit 141 performs filtering on the associated fine granularity flow 300 at a predetermined time and in a predetermined field. Then, the traffic visualization unit 141 collects and draws statistical information included in the associated fine granularity flow 300 after the filtering, and provides the traffic visualization information 221 for a user (step S18).

The path visualization unit 142 performs filtering on the associated fine granularity flow 300 at a predetermined time and in a predetermined field. Then, the path visualization unit 142 provides the path visualization information 222 for the user by collecting the router ID, the input IF ID, and the output IF ID included in the associated fine granularity flow 300 after the filtering, mapping them on the topology information, and drawing the topology information (step S19).

The geographic visualization unit 143 performs filtering on the associated fine granularity flow 300 at a predetermined time and in a predetermined field. Then, the geographic visualization unit 143 provides the user with the geographic visualization information 223 by collecting the latitude and longitude information included in the associated fine granularity flow 300 after the filtering and drawing a map representing a distribution of communication (step S20).

The earth alternating current visualization unit 144 performs filtering on the associated fine granularity flow 300 at a predetermined time and in a predetermined field. Then, the earth alternating current visualization unit 144 collects the destination PE MPLS label, and IP addresses and MAC addresses of a transmission destination and a transmission source of a packet included in the associated fine granularity flow 300 after the filtering, generates and draws earth alternating current information, thereby providing the earth alternating current visualization information 224 for the user (step S21).

### [Effects of Network Information Visualization Device]

As described above, the network information visualization device 1 associates the topology 212, the MP-BGP information 213, the device information 214, and the geographic information 215 with the fine granularity flow 211 acquired from the VPN network 2, and generates the associated fine granularity flow 300. Thereafter, the network information visualization device 1 generates the traffic visualization information 221, the path visualization information 222, the geographic visualization information 223, and the earth alternating current visualization information 224 by using the associated fine granularity flow 300, and provides them for the user.

By visualizing the traffic time series by the traffic visualization information 221, for example, the presence or absence of DDoS attack can be detected. Further, by visualizing the traffic time series by the traffic visualization information 221, for example, OTT communication abnormality can be confirmed, and for example, it can be indicated that there is no cause on the VPN network 2 side.

In addition, by the path visualization information 222, for example, paths before and after a user claim can be compared, and routers to be checked for the presence or absence of abnormality can be quickly narrowed down. Furthermore, by the path visualization information 222, for example, at the time of a router or a link failure, VPN communication via the failed device can be enumerated, and the affected VPN can be quickly grasped.

In addition, by visualizing the geographic distribution of communication by the geographic visualization information 223, for example, DC attraction of MEC can be performed on the basis of a geographic distribution of APL use. Furthermore, by visualizing the geographic distribution of communication by the geographic visualization information 223, it is possible to grasp communication in an area at the time of disaster, for example.

In addition, by the earth alternating current visualization information 224, it is easy to confirm where to add a new link when performing provisioning, for example.

As described above, the network information visualization device 1 according to the present embodiment can visualize various types of information useful for operation of the VPN network 2 and provide the visualized information for the user. Then, reliability of the network can be improved by the user operating the network using the information provided by the network information visualization device 1.

### [System Configuration and Others]

Moreover, each component of each illustrated device is functionally conceptual, and does not necessarily need to be physically configured as illustrated. That is, a specific form of distribution and integration of each device is not limited to the illustrated form, and all or some thereof can be functionally or physically distributed or integrated in any unit according to various loads, use status, and the like. Furthermore, all or some of each processing function performed in each device can be realized by a central processing unit (CPU) and a program analyzed and executed by the CPU, or may be realized as hardware by wired logic.

Further, among the processing described in the present embodiment, all or some of processing described as being automatically performed can be manually performed, or all or some of processing described as being manually performed can be automatically performed by a known method. In addition, processing procedures, control procedures, specific name, and information including various kinds of data and parameters illustrated in the specification and the drawings can be arbitrarily changed unless otherwise specified.

### [Program]

As an embodiment, the network information visualization device 1 can be implemented by installing, on a desired computer, a network information visualization program for executing the above information processing as packaged software or online software. For example, by causing the information processing device to execute the network information visualization program described above, the information processing device can be caused to function as the network information visualization device 1. The information processing device mentioned here includes a desktop or a laptop personal computer. Alternatively, the information processing device may be a mobile communication terminal such as a smartphone, a mobile phone, and a personal handy-phone system (PHS), a slate terminal such as a personal digital assistant (PDA), and the like.

Furthermore, the network information visualization device 1 can also be implemented as an information providing server device that sets a terminal device used by a user as a client and provides the client with a service related to the network information visualization processing described above. For example, the information providing server device is implemented as a server device that provides a service for outputting a network information visualization image according to a time or a field value with the time or the field value as an input. In this case, the information providing server device may be implemented as a Web server, or may be implemented as a cloud that provides a service related to the network information visualization processing described above by outsourcing.

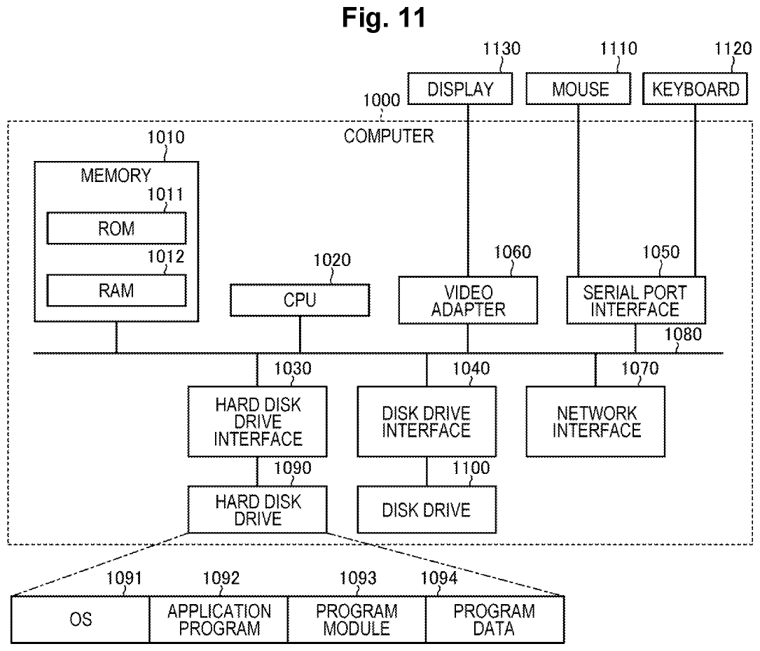

FIG. 11 is a diagram illustrating an example of a computer that executes the network information visualization program. A computer 1000 includes a memory 1010 and a CPU 1020, for example. In addition, the computer 1000 includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores a boot program such as a basic input output system (BIOS), for example. The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an OS 1091, an application program 1092, a program module 1093, and program data 1094. That is, a classification program that defines each processing of the network information visualization device 1 having a function equivalent to that of the network information visualization device 1 is implemented as the program module 1093 in which a code executable by the computer is described. The program module 1093 is stored in, for example, the hard disk drive 1090. For example, the program module 1093 for executing processing similar to a functional configuration in the network information visualization device 1 is stored in the hard disk drive 1090. Note that the hard disk drive 1090 may be replaced with a solid state drive (SSD).

In addition, setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). Then, the program module 1093 and the program data 1094 may be read by the CPU 1020 from the other computer via the network interface 1070.

### REFERENCE SIGNS LIST

1 Network information visualization device
2 VPN network
11 Information acquisition unit
12 Association unit
13 Data storage unit
14 Visualization unit
111 Fine granularity flow acquisition unit
112 Topology acquisition unit
113 MP-BGP information acquisition unit
114 Device information acquisition unit
115 Geographic information acquisition unit
141 Traffic visualization unit
142 Path visualization unit
143 Geographic visualization unit
144 Earth alternating current visualization unit

1. A network information visualization device comprising:
an information acquisition unit that acquires network information regarding a predetermined virtual private network (VPN) network including at least flow information having statistical information regarding communication in the predetermined VPN network;
an association unit that associates the flow information with another network information included in the network information and generates associated flow information; and
a visualization unit that generates visualization information in which the flow information is associated with the other network information based on the associated flow information.

2. The network information visualization device according to claim 1, wherein the visualization unit generates traffic visualization information that is the visualization information obtained by visualizing a traffic time series regarding a predetermined VPN or a predetermined communication interface at a predetermined time based on the statistical information.

3. The network information visualization device according to claim 1, wherein the information acquisition unit acquires the flow information including identification information regarding a plurality of network devices arranged in the predetermined VPN network, and a topology including the identification information regarding the network devices and topology information indicating a connection relationship between the network devices,
the association unit associates the identification information regarding the network devices with the topology information, and
the visualization unit generates path visualization information that is the visualization information obtained by visualizing a path through which predetermined communication has passed at a predetermined time based on the identification information regarding the network devices, the topology information, and the statistical information.

4. The network information visualization device according to claim 3, wherein the information acquisition unit acquires geographic information including the topology information and location information on the network devices,
the association unit associates the topology information with the location information, and
the visualization unit generates geographic visualization information that is the visualization information obtained by visualizing a geographical distribution of predetermined communication at a predetermined time based on the identification information regarding the network devices, the location information, and the statistical information.

5. The network information visualization device according to claim 3, wherein the information acquisition unit acquires the flow information including VPN communication setting information regarding signal transmission and reception in VPNs existing in the predetermined VPN network, VPN information including the VPN communication setting information and VPN identification information for identifying the VPNs, and device information including the VPN identification information, device setting information and operating state information on the network devices,
the association unit associates the VPN communication setting information with the VPN identification information, and
the visualization unit generates, based on the statistical information and the device information, earth alternating current visualization information that is the visualization information obtained by visualizing an earth alternating current between predetermined network devices at a predetermined time.

6. A network information visualization method comprising:
an information acquisition step of acquiring network information regarding a predetermined VPN network including at least flow information having statistical information regarding communication in the predetermined VPN network;
an association step of associating the flow information with another network information included in the network information and generating associated flow information; and
a visualization step of generating visualization information in which the flow information is associated with the other network information based on the associated flow information.

7. A network information visualization program for causing a computer to execute:
an information acquisition step of acquiring network information regarding a predetermined VPN network including at least flow information having statistical information regarding communication in the predetermined VPN network;
an association step of associating the flow information with another network information included in the network information and generating associated flow information; and
a visualization step of generating visualization information in which the flow information is associated with the other network information based on the associated flow information.

8. A network information visualization system comprising a network information visualization device that visualizes a predetermined VPN network and network information in the predetermined VPN network, wherein
the network information visualization device includes:
an information acquisition unit that acquires the network information regarding the predetermined VPN network including at least flow information including statistical information regarding communication in the predetermined VPN network;
an association unit that associates the flow information with another network information included in the network information and generates associated flow information; and
a visualization unit that generates visualization information in which the flow information is associated with the other network information based on the associated flow information.

9. The network information visualization method according to claim 6, further comprising:
a generating step of generating traffic visualization information that is the visualization information obtained by visualizing a traffic time series regarding a predetermined VPN or a predetermined communication interface at a predetermined time based on the statistical information.

10. The network information visualization method according to claim 6, further comprising:
the information acquisition step of acquiring the flow information including identification information regarding a plurality of network devices arranged in the predetermined VPN network, and a topology including the identification information regarding the network devices and topology information indicating a connection relationship between the network devices,
the association step of associating the identification information regarding the network devices with the topology information, and
the visualization step of generating path visualization information that is the visualization information obtained by visualizing a path through which predetermined communication has passed at a predetermined time based on the identification information regarding the network devices, the topology information, and the statistical information.

11. The network information visualization method according to claim 6, wherein
acquiring geographic information including the topology information and location information on the network device,
associating the topology information with the location information, and
generating geographic visualization information that is the visualization information obtained by visualizing a geographical distribution of predetermined communication at a predetermined time based on the identification information regarding the network devices, the location information, and the statistical information.

12. The network information visualization method according to claim 6, wherein the flow information including VPN communication setting information regarding signal transmission and reception in VPNs existing in the predetermined VPN network and VPN information including the VPN communication setting information and VPN identification information for identifying the VPNs, and device information including the VPN identification information, device setting information and operating state information on the network devices are acquired,
the VPN communication setting information with the VPN identification information is associated, and
based on the statistical information and the device information, earth alternating current visualization information that is the visualization information obtained by visualizing an earth alternating current between predetermined network devices at a predetermined time is generated.

13. The network information visualization program according to claim 7, further comprising:
a generating step of generating traffic visualization information that is the visualization information obtained by visualizing a traffic time series regarding a predetermined VPN or a predetermined communication interface at a predetermined time based on the statistical information.

14. The network information visualization program according to claim 7, further comprising:
the information acquisition step of acquiring the flow information including identification information regarding a plurality of network devices arranged in the predetermined VPN network, and a topology including the identification information regarding the network devices and topology information indicating a connection relationship between the network devices,
the association step of associating the identification information regarding the network devices with the topology information, and
the visualization step of generating path visualization information that is the visualization information obtained by visualizing a path through which predetermined communication has passed at a predetermined time based on the identification information regarding the network devices, the topology information, and the statistical information.

15. The network information visualization program according to claim 7, wherein
acquiring geographic information including the topology information and location information on the network device,
associating the topology information with the location information, and
generating geographic visualization information that is the visualization information obtained by visualizing a geographical distribution of predetermined communication at a predetermined time based on the identification information regarding the network devices, the location information, and the statistical information.

16. The network information visualization program according to claim 7, wherein the flow information including VPN communication setting information regarding signal transmission and reception in VPNs existing in the predetermined VPN network and VPN information including the VPN communication setting information and VPN identification information for identifying the VPNs, and device information including the VPN identification information, device setting information and operating state information on the network devices are acquired,
the VPN communication setting information with the VPN identification information is associated, and
based on the statistical information and the device information, earth alternating current visualization information that is the visualization information obtained by visualizing an earth alternating current between predetermined network devices at a predetermined time is generated.

17. The network information visualization system according to claim 8, further comprising:
a generating step of generating traffic visualization information that is the visualization information obtained by visualizing a traffic time series regarding a predetermined VPN or a predetermined communication interface at a predetermined time based on the statistical information.

18. The network information visualization system according to claim 8, further comprising:
the information acquisition step of acquiring the flow information including identification information regarding a plurality of network devices arranged in the predetermined VPN network, and a topology including the identification information regarding the network devices and topology information indicating a connection relationship between the network devices,
the association step of associating the identification information regarding the network devices with the topology information, and
the visualization step of generating path visualization information that is the visualization information obtained by visualizing a path through which predetermined communication has passed at a predetermined time based on the identification information regarding the network devices, the topology information, and the statistical information.

19. The network information visualization system according to claim 8, wherein
acquiring geographic information including the topology information and location information on the network device,
associating the topology information with the location information, and
generating geographic visualization information that is the visualization information obtained by visualizing a geographical distribution of predetermined communication at a predetermined time based on the identification information regarding the network devices, the location information, and the statistical information.

20. The network information visualization system according to claim 8, wherein the flow information including VPN communication setting information regarding signal transmission and reception in VPNs existing in the predetermined VPN network and VPN information including the VPN communication setting information and VPN identification information for identifying the VPNs, and device information including the VPN identification information, device setting information and operating state information on the network devices are acquired,
the VPN communication setting information with the VPN identification information is associated, and
based on the statistical information and the device information, earth alternating current visualization information that is the visualization information obtained by visualizing an earth alternating current between predetermined network devices at a predetermined time is generated.
